(19) United States
(12) Patent Application Publication
(10) Pub. No.: US 2018/0018400 A1
(43) Pub. Date: Jan. 18, 2018

(54) PRESENTATION BIAS COMPENSATION FOR MULTIPLE ITEM INTERNET WEB PAGES

(71) Applicant: eBay Inc., San Jose, CA (US)

(72) Inventors: Alex Cozzi, San Jose, CA (US); David Goldberg, Palo Alto, CA (US)

(21) Appl. No.: 15/209,445

(22) Filed: Jul. 13, 2016

(51) Int. Cl. G06F 17/30; G06F 3/0484; H04L 29/08

(52) U.S. Cl. CPC G06F 17/30905; H04L 67/02; G06F 3/04842; G06F 17/3053; G06F 17/3089

(57) ABSTRACT

Embodiments of the present disclosure can be used to compensate for presentation bias and estimate click-through rates for content objects in different positions on an Internet web page. Among other things, this allows Internet web page content to be positioned on the web page without necessitating extensive real-world testing, thereby providing better content to users more quickly and efficiently than conventional systems.

### TECHNICAL FIELD

Embodiments of the present disclosure relate generally to presenting content on Internet web pages, and more particularly, but not by way of limitation, to compensating for presentation bias while presenting multiple content items on Internet web pages.

### BACKGROUND

Internet web pages are used to present a wide variety of content. In many cases, the position of content items/objects (such as links) within a web page can affect the likelihood of such content being accessed (e.g., clicked on) or even seen by a user. The popularity of a content object on a web page is often measured in the “click-through rate” or “CTR,” which is the percentage of users of a web page that click on the content item. However, the “best” position to optimize the CTR of a content item may not be clear without extensive and lengthy testing using actual users, during which relatively “better” content object may be presented in suboptimal positions on the web page.

This is due, at least in part, to content objects placed in relatively higher-ranked positions (e.g., the first result in a list) generally receiving a higher CTR than a second content object in a relatively worse position (e.g., on the third page of a list), even when the second content object is a more useful (or otherwise better) content item for the user. This is often referred to as “presentation bias,” because the presentation (i.e., position in the web page) of the content item alone (regardless of its quality) has a significant effect on the content item's CTR and thus can distort measurements as to the actual popularity/effectiveness of a particular content item relative to other items. Embodiments of the present disclosure address these and other issues.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an exemplary networked system, according to various embodiments.

FIG. 2 is a flow diagram of an exemplary process according to various embodiments.

FIGS. 3A-3F illustrate aspects of compensating for presentation bias in multiple item Internet web pages according to various embodiments.

FIG. 4 is a block diagram of an exemplary machine in the form of a computer system within which a set of instructions may be executed for causing the machine to perform various functionality.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Embodiments of the present disclosure can be used to compensate for presentation bias and estimate click-through rates for content objects in different positions on an Internet web page. Among other things, this allows Internet web page content to be positioned on the web page without necessitating extensive real-world testing, thereby providing better content to users more quickly and efficiently than conventional systems.

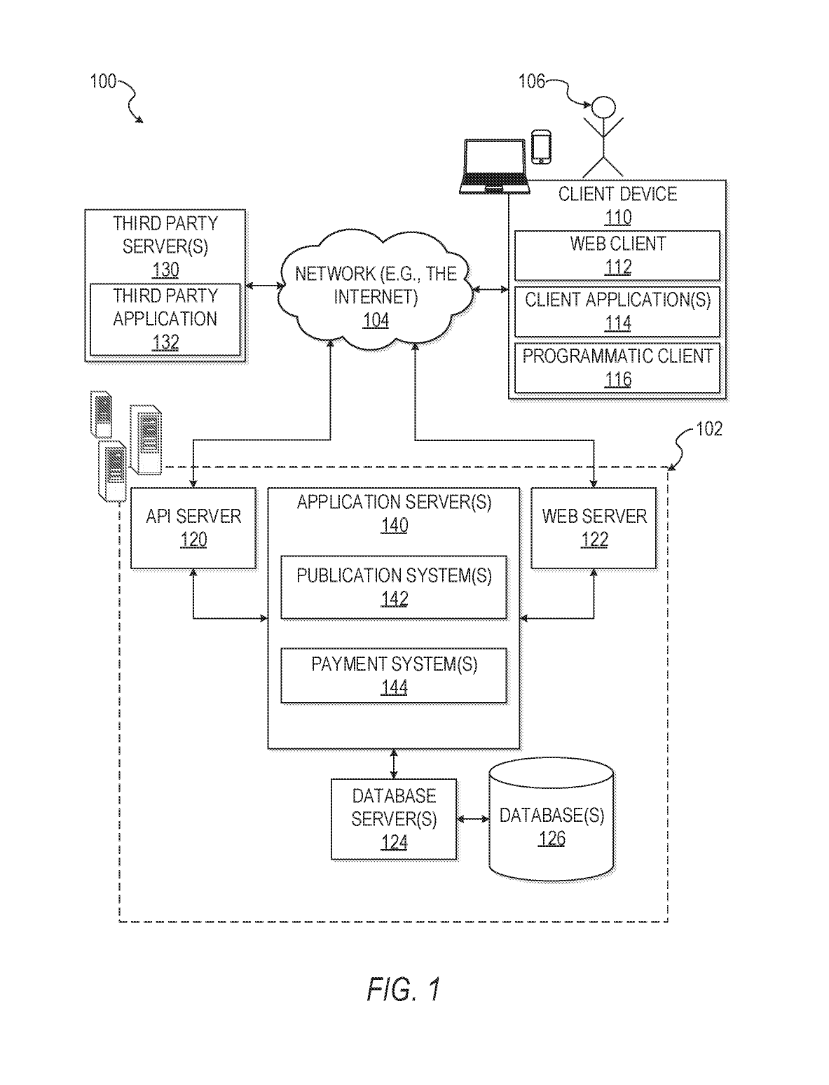

With reference to FIG. 1, an exemplary embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but is not limited to, various types of mobile devices, such as portable digital assistants (PDAs), smart phones, tablets, ultra books, multi-processor systems, microprocessor-based or programmable consumer electronics, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other entity for interacting with client device 110. In embodiments, the user 106 is not part of the network architecture 100, but may interact with the network architecture 100 via client device 110 or another systems and devices. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment). Conversely if the e-commerce site application is not included in the client device 110, the client device 110 may use its web browser to access the e-commerce site (or a variant thereof) hosted on the networked system 102.

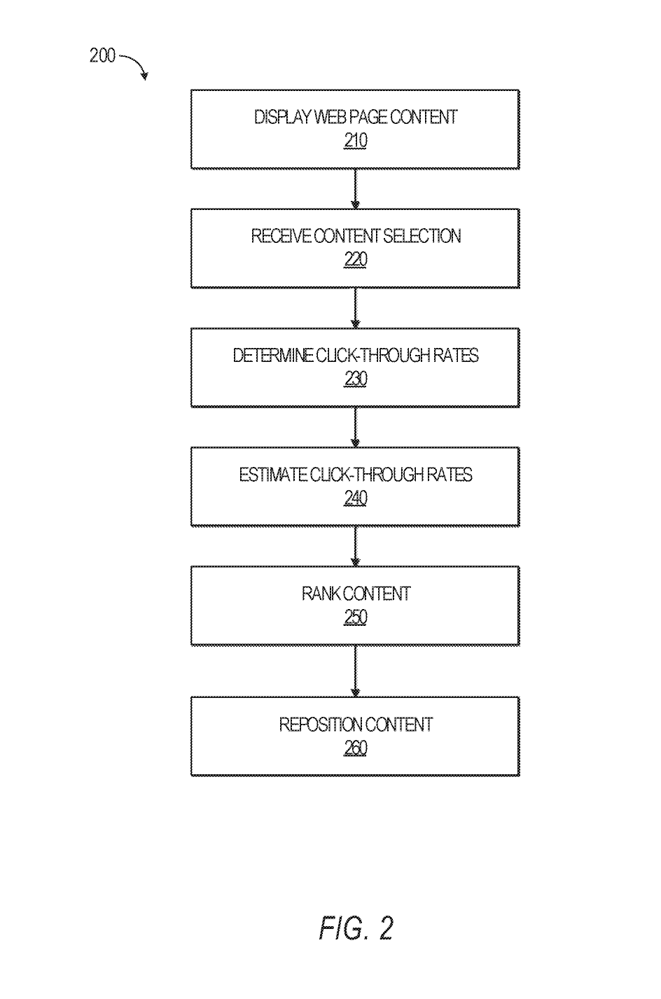

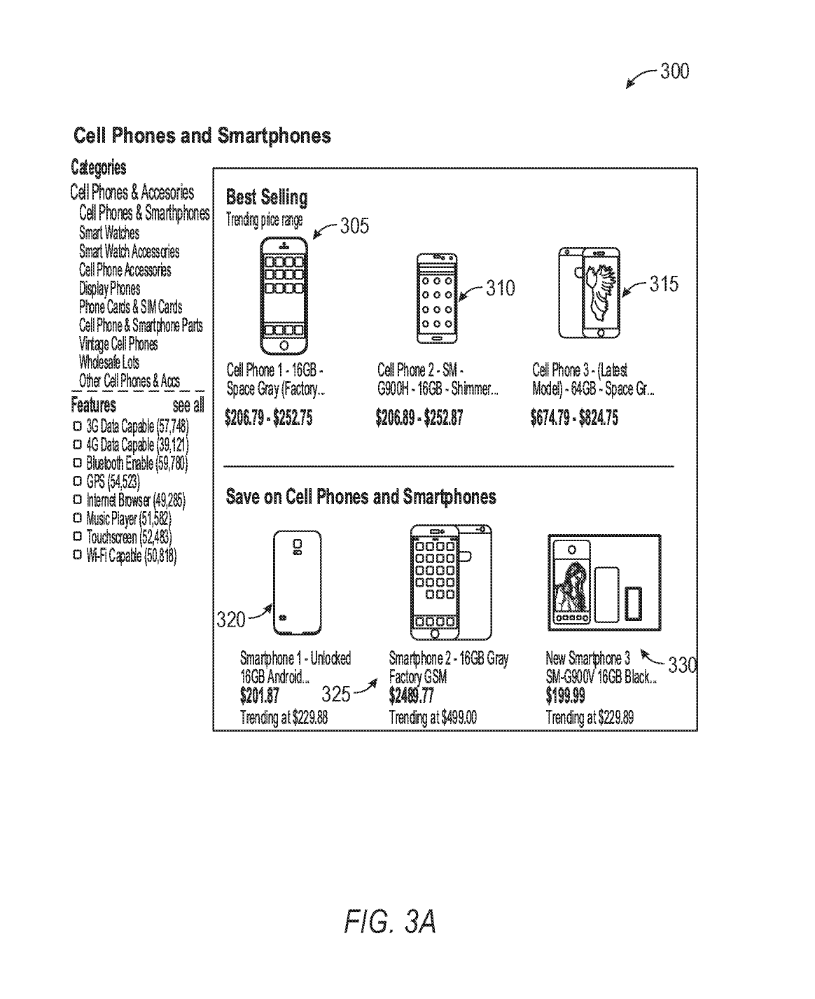

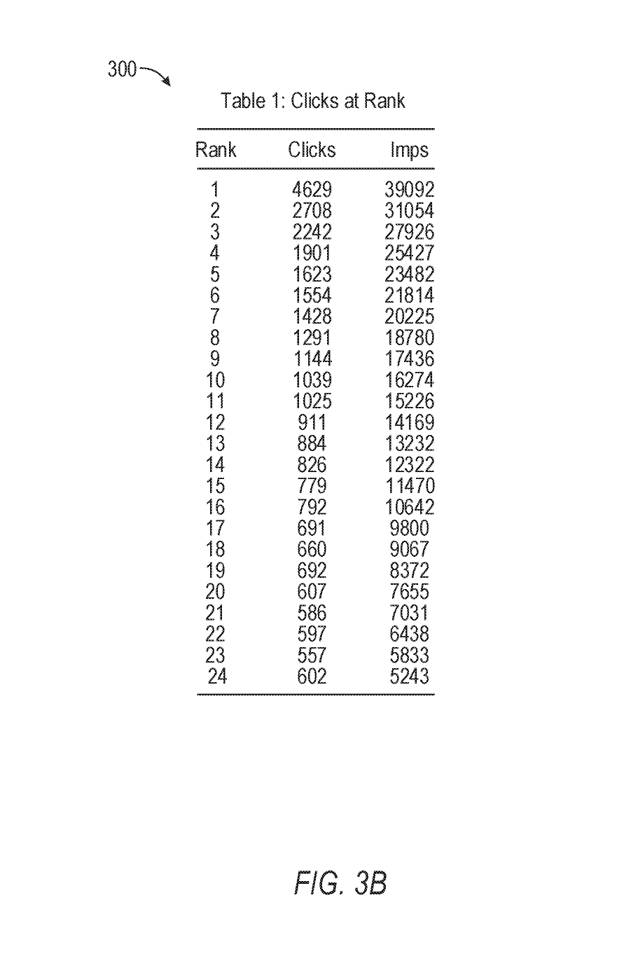

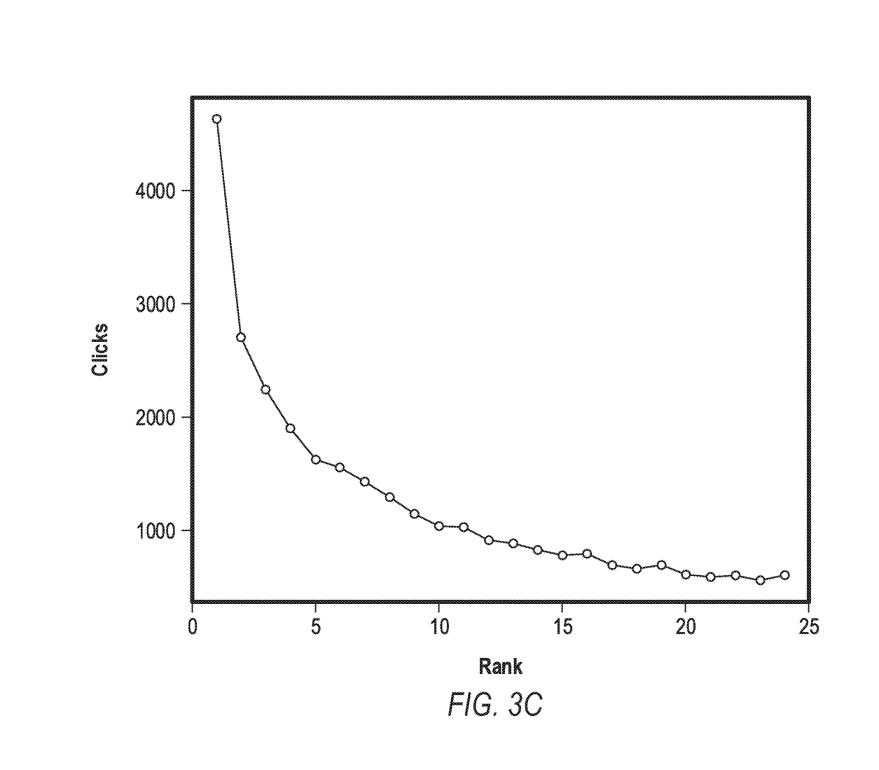

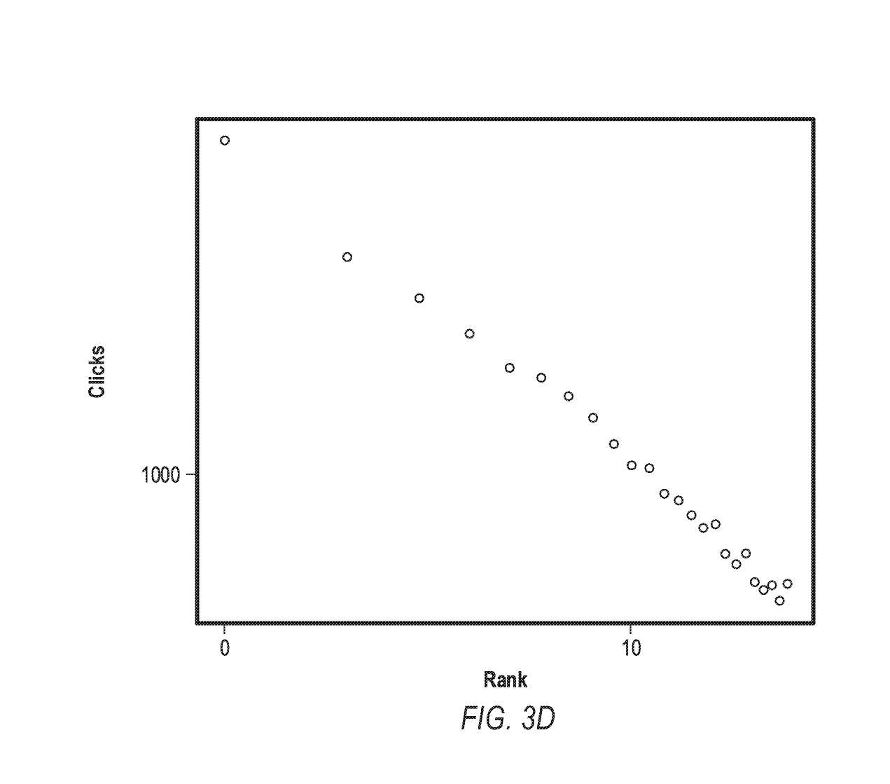

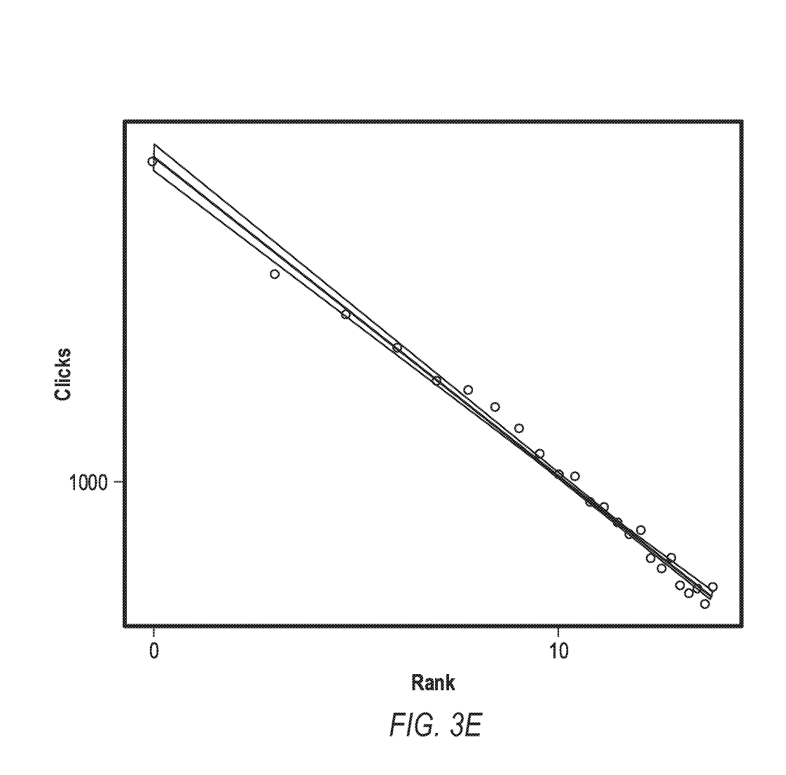

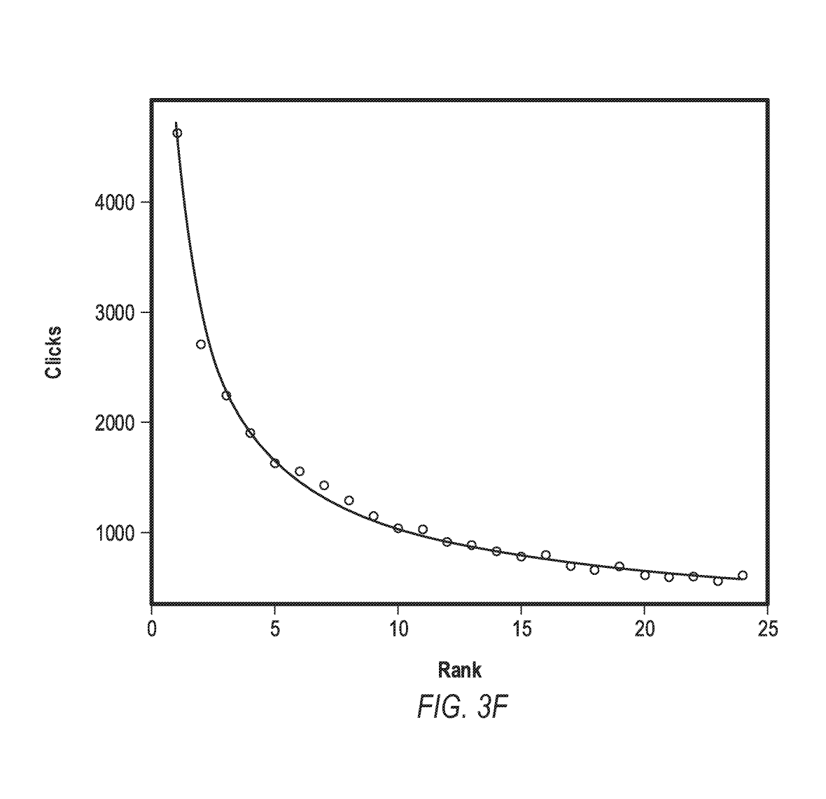

One or more users 106 may be a person, a machine, or other entity for interacting with the client device 110. In some exemplary embodiments, the user 106 is not part of the network architecture 100, but may interact with the network architecture 100 via the client device 110. For instance, the user 106 provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user 106. In this way, the user 106 can interact with the networked system 102 using the client device 110. For example, with reference to FIGS. 2 and 3A-3F discussed below, a plurality of client devices 110 associated with a respective plurality of users 106 may be directed to display Internet web page content received from the networked system 102 and/or third party servers 130 and send selections of such content over the Internet 104 to the third party servers 130 and/or networked system 102.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an exemplary embodiment, the databases 126 are storage devices that store information to be posted (e.g., publications or listings) to the publication system 120. The databases 126 may also store digital item information in accordance with exemplary embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication system 142 provides a number of publication functions and services to users 106 that access the networked system 102. The payment system 144 likewise provides a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142 and payment system 144 could also be implemented as standalone software programs, which do not necessarily have networking capabilities.

The web client 112 may access the various publication and payment systems 142 and 144 via the web interface supported by the web server 122, including web pages hosted by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

FIG. 2 depicts an exemplary method 200 according to various aspects of the present disclosure. Embodiments of the present disclosure may practice the steps of method 200 in whole or in part, and in conjunction with any other desired systems and methods. The functionality of method 200 may be performed, for example using any combination of the systems depicted in FIGS. 1 and/or 4.

In the example depicted in FIG. 2, method 200 includes displaying content in a web page to one or more users over the Internet (210), receiving a selection of content on the Internet web page from one or more users (220), determining a click-through rate for a content objects on the web page based on the selections (230), estimating a click-through rate for the content objects at a particular ranked position within the web page (240), ranking the content objects based on their respective estimated click-through rates (250), and repositioning one or more content items (260) based on the ranking.

Embodiments of the present disclosure may display web page content (210) in a variety of different ways. For example, the third party servers 130 and/or networked system 102 may host one or more Internet web pages for display on the client devices 110. FIG. 3A illustrates an example of an Internet web page displayed in response to a user performing a search, such as for “cell phones and smartphones.” In this example, web page 300 displays the first six content items/objects (images of different smartphones with links to more information about each smartphone), each object in a respective position in the web page.

The web page 300 (or variants thereof) may be displayed (210) to any number of different users, and the web page need not necessarily be displayed in the same manner to every user. For example, the content objects may be different for different users, and/or content objects may be displayed in different positions in the web page, as well as using an entirely different format than another web page.

Embodiments of the present disclosure receive content selections (220) from users viewing the web page(s), and such content selections may include a variety of different information about the user's interaction with the web page. For example, the system may receive an indication that a user selected (e.g., clicked on) a particular content object (such as one or more of the images/links in the list of smartphones shown in FIG. 3A) as well as the time the user spent on the web page, information on other content objects the user accessed, and other information.

Content selections may comprise selections of any number of content objects in any number of different positions on a web page, and may be received from any number of different users. In some cases, the content selections may include selections of a content object positioned in different positions in the web page. For example, the content item may be displayed in multiple positions in the same list of content items. In another example, the content item may be displayed in a first position on the page to a first user or group of users, and displayed in a second position on the page to a second user or group of users in a different version of the web page. The content selections may be used to determine (230) click-through rates for content objects in different positions in the web page and the determined click-through rates at the different positions used to estimate (240) the click-through rate for the content objects at other positions in the page.

The system may compile the content selection information from multiple users and determine (230), based on the content selections a click-through rate for one or more content objects in one or more positions on the Internet web page. Consider an example where the web page 300 in FIG. 3A includes twenty-four different content objects in twenty-four respective positions (where the illustration in FIG. 3A shows the first six). The page may be displayed to users for a predetermined period of time and content selection information received by the system during that period. FIG. 3B is a table showing an exemplary set of such content selection information for each of the twenty-four content positions (labeled “ranks”), namely the number of click-throughs (labeled (“clicks”) each content item receives versus the number of times a user views the content object (labeled “imps” for “impressions”). FIG. 3C is a graph of the clicks vs. impressions for each content position rank. Consider a simple ranking, where the “rank 1” content position is in the upper-left (position 305 in FIG. 3A), the “rank 2” content position is position 310, and ranks 3, 4, 5, and 6 correspond to positions 315, 320, 325, and 330, respectively.

As shown in the table in FIG. 3B and the graph in FIG. 3C, the content object in the rank 1 position 310 receives the highest total number of impressions and the highest total number of click-throughs. As discussed previously, at least part of position 310's popularity is due to it being the first result in the list, independent of the quality of the actual content item displayed in the position. In other words, though it has the highest number of impressions and click-throughs, the content item in position 310 may not necessarily be the highest quality content item in the list (e.g., not the best search result for the user's “smartphone” search in the example shown in FIG. 3A).

Embodiments of the disclosure may estimate (240) click-through rates for any number of different content objects in any number of different positions within a web page. In some cases, for example, a content provider or web host may wish to know which content items are “better” quality than other content items in a selection of content items. Content items can then be added to, removed from, or repositioned on (260) a web page accordingly.

In some exemplary embodiments, the quality of a content item can be identified in the context of a particular display of content on a web page, and a content item that may be of a very high value/quality in one context may be of little value/quality in another. For instance, consider the example in FIG. 3A where a list of content items are displayed to a user in response to a search for “cell phones and smart phones.” A link to a relatively well-priced, popular smartphone in such a context may be considered a comparatively “better” content item than a link to a tablet computing device. In another context, however, such as a list of content items provided in response to a search for “tablet computers,” the opposite could be true. Embodiments of the present disclosure take an algorithmic approach to ranking content items in the context of different web page presentations, and thus allow for the automatic and efficient ranking and positioning of content items on a web page.

In some exemplary embodiments, a click-through rate for two different content objects having two different positions on a web page is determined (230) based on content selections received (220) from one or more users. Based on the determined click-through rates for each content item in their respective positions, an estimated click-through rate is determined (240) for both content objects at a third position, such as the highest ranked position on the web page. In the exemplary web page in FIG. 3A, the highest ranked position would be the first result 305 on the page 300.

Some embodiments may estimate (240) the click-through rate for a content object at a particular position in a web page based on a linear model using the determined click-through rate(s) for the content object. For example, applying a linear model to the curve shown in FIG. 3C results in the plot of points shown in FIG. 3D, to which a linear fit is applied as shown in FIG. 3E, where the intercept is 8.4631 and the log(rank) equals −0.6626.

Applying a logarithmic transformation to the linear model gives us the logarithmic curve in FIG. 3F, according to the following:

log(y)=8.463−0.663 log(x)

y=exp(8.463−0.663 log(x))

y=exp(8.463)exp(−0.663 log(x))

y=4736.24·x^{-0.663}

Where y is the estimated number of clicks given the rank x. To estimate the number of clicks at the highest ranked position 305, we substitute:

y=4736.24·x^{-0.663}

y=4736.24·log(1)^{-0.663}

y=4736.24·1

y=4736.24

Which gives an estimate of 4736 clicks at rank 1, as opposed to the actual observed value of 4629 clicks shown in FIG. 3B. In order to be able to compare the engagement across different queries, the click-through ratio (CTR) is used, normalizing the clicks by dividing it by the number of impressions (i.e. the number of times the page was shown to the user). In the case of our example the impression count is 39092, which gives us an estimated CTR of 0.1211501. Compare this with the CTR at rank 1 based on the observed clicks, which is 0.118413.

In this manner, the estimated click-through rate for multiple content objects in a particular position (or positions) in a web page can be estimated based on their positions anywhere in the web page, without actually testing the content object in the position. The content objects can thus be more quickly and efficiently ranked (250) according to their quality in a particular web page setting. The content may be ranked in any suitable manner, such as in an ordered list according to quality, or based on other criteria.

Based on the ranking, one or more content objects may be repositioned (260) within a web page. In some cases, the content may be repositioned automatically and without user intervention. In other cases, an alert or other message may be generated by the system to allow an operator (or a monitoring system) to approve the repositioning.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some exemplary embodiments, the processors or processor-implemented modules may be located in a single geographic location (e.g., within a home environment, an office environment, or a server farm). In other exemplary embodiments, the processors or processor-implemented modules may be distributed across a number of geographic locations.

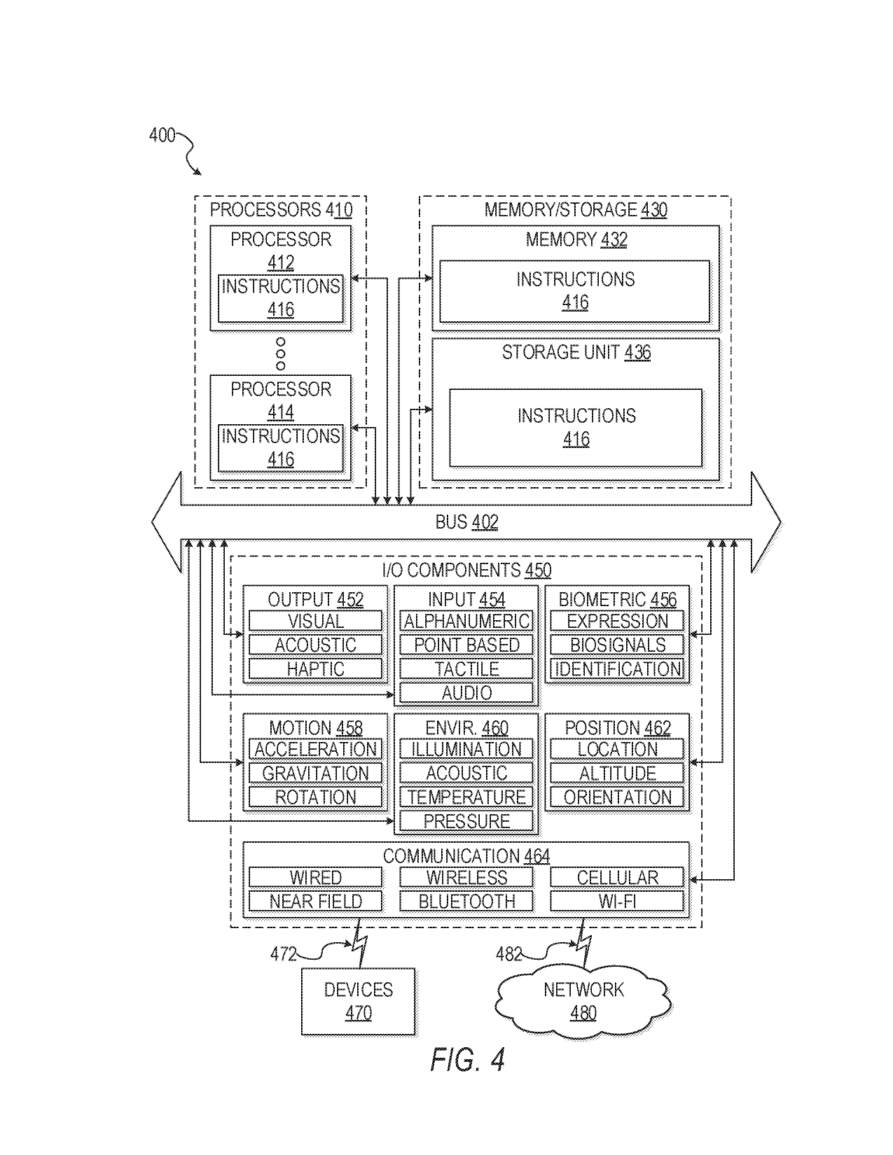

FIG. 4 is a block diagram illustrating components of a machine 400, according to some exemplary embodiments, able to read instructions from a machine-readable medium (e.g., a machine-readable storage medium) and perform any one or more of the methodologies discussed herein. Specifically, FIG. 4 shows a diagrammatic representation of the machine 400 in the example form of a computer system, within which instructions 416 (e.g., software, a program, an application, an applet, an app, or other executable code) for causing the machine 400 to perform any one or more of the methodologies discussed herein may be executed.

The computer system 400 may be a client computing device, such as client device 110 in FIG. 1, and may store instructions in its memory 432 to cause the computer system 400 to execute the steps in method 200 shown in FIG. 2. The instructions transform the general, non-programmed machine into a particular machine programmed to carry out the described and illustrated functions in the manner described. The computer system 400 may operate as a standalone device or may be coupled (e.g., networked) to other systems and devices. In a networked deployment, the computer system 400 may operate in the capacity of a client machine in a server-client network environment or as a peer machine in a peer-to-peer (or distributed) network environment. The computer system 400 may comprise, but not be limited to, a personal computer (PC), a tablet computer, a laptop computer, a netbook, a personal digital assistant (PDA), a cellular telephone, a smart phone, a mobile device, a wearable device (e.g., a smart watch), a smart home device (e.g., a smart appliance), other smart devices, or any machine capable of executing the instructions 416, sequentially or otherwise, that specify actions to be taken by computer system 400. Further, while only a single computer system 400 is illustrated, the term “machine” or “computer system” shall also be taken to include a collection of machines/computer systems 400 that individually or jointly execute the instructions 416 to perform any one or more of the methodologies discussed herein.

The computer system 400 may include processors 410, memory 430, and I/O components 450, which may be configured to communicate with each other such as via a bus 402. In an exemplary embodiment, the processors 410 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 412 and processor 414 that may execute instructions 416. The term “processor” is intended to include multi-core processor that may comprise two or more independent processors (sometimes referred to as “cores”) that may execute instructions contemporaneously. Although FIG. 4 shows multiple processors, the computer system 400 may include a single processor with a single core, a single processor with multiple cores (e.g., a multi-core process), multiple processors with a single core, multiple processors with multiples cores, or any combination thereof.

The memory/storage 430 may include a memory 432, such as a main memory, or other memory storage, and a storage unit 436, both accessible to the processors 410 such as via the bus 402. The storage unit 436 and memory 432 store the instructions 416 embodying any one or more of the methodologies or functions described herein. The instructions 416 may also reside, completely or partially, within the memory 432, within the storage unit 436, within at least one of the processors 410 (e.g., within the processor's cache memory), or any suitable combination thereof, during execution thereof by the computer system 400. Accordingly, the memory 432, the storage unit 436, and the memory of processors 410 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 416. The term “machine-readable medium” shall also be taken to include any medium, or combination of multiple media, that is capable of storing instructions (e.g., instructions 416) for execution by a machine (e.g., computer system 400), such that the instructions, when executed by one or more processors of the computer system 400 (e.g., processors 410), cause the computer system 400 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 450 may include a wide variety of components to receive input, provide output, produce output, transmit information, exchange information, capture measurements, and so on. The specific I/O components 450 that are included in a particular machine will depend on the type of machine. For example, portable machines such as mobile phones will likely include a touch input device or other such input mechanisms, while a headless server machine will likely not include such a touch input device. It will be appreciated that the I/O components 450 may include many other components that are not shown in FIG. 4. The I/O components 450 are grouped according to functionality merely for simplifying the following discussion and the grouping is in no way limiting. In various exemplary embodiments, the I/O components 450 may include output components 452 and input components 454. The output components 452 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 454 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further exemplary embodiments, the I/O components 450 may include biometric components 456, motion components 458, environmental components 460, or position components 462 among a wide array of other components. For example, the biometric components 456 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 458 may include acceleration sensor components (e.g., accelerometer), gravitation sensor components, rotation sensor components (e.g., gyroscope), and so forth. The environmental components 460 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 462 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 450 may include communication interface 464 operable to couple the computer system 400 to a network 480 or devices 470 via coupling 482 and coupling 472 respectively. For example, the communication interface components 464 may include a network interface component or other suitable device to interface with the network 480. In further examples, communication interface 464 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 470 may be another machine or any of a wide variety of peripheral devices (e.g., a peripheral device coupled via a Universal Serial Bus (USB)).

Moreover, the communication interface components 464 may detect identifiers or include components operable to detect identifiers. For example, the communication components 464 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 464, such as, location via Internet Protocol (IP) geo-location, location via Wi-Fi® signal triangulation, location via detecting a NFC beacon signal that may indicate a particular location, and so forth.

In various exemplary embodiments, one or more portions of the network 480 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 480 or a portion of the network 480 may include a wireless or cellular network and the coupling 482 may be a Code Division Multiple Access (CDMA) connection, a Global System for Mobile communications (GSM) connection, or other type of cellular or wireless coupling. In this example, the coupling 482 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 416 may be transmitted or received over the network 480 using a transmission medium via a network interface device (e.g., a network interface component included in the communication components 464) and utilizing any one of a number of well-known transfer protocols (e.g., hypertext transfer protocol (HTTP)). Similarly, the instructions 416 may be transmitted or received using a transmission medium via the coupling 472 (e.g., a peer-to-peer coupling) to devices 470. The term “transmission medium” shall be taken to include any intangible medium that is capable of storing, encoding, or carrying instructions 416 for execution by the computer system 400, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific exemplary embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

What is claimed is:

1. A system comprising:
a processor; and
memory coupled to the processor and storing instructions that, when executed by the processor, cause the system to perform operations comprising:
displaying content in a web page to a plurality of users over the Internet;
receiving, by the system over the Internet, a selection of the content in the Internet web page from the plurality of users, wherein the content comprises a first content object and a second content object, the first content object having a first page position on the Internet web page and the second content object having a second page position on the Internet web page;
determining, based on the selection of the content by the plurality of users, a click through rate for the first content object in the first page position and a click through rate for the second content object in the second page position;
estimating, based on the determined click through rate for the first content object, a click through rate for the first content object at a third page position on the Internet web page;
estimating, based on the determined click through rate for the second content object, a click through rate for the second content object at the third page position on the Internet web page;
ranking the first content object and the second content object based on the estimated click through rate for the first content object and the estimated click through rate for the second content object.

2. The system of claim 1, wherein the third page position is a highest ranked position on the Internet web page.

3. The system of claim 1, wherein the memory further stores instructions for repositioning one or more of the first content object and the second content object on the Internet web page in response to the ranking of the first content object and the second content object.

4. The system of claim 1, wherein receiving the selection of the content in the Internet web page includes receiving selections of a plurality of content objects in a respective plurality of positions on the Internet web page from the plurality of users.

5. The system of claim 1, wherein receiving the selection of the content in the Internet web page includes receiving selections for the first content object displayed to the plurality of users in a plurality of positions on a respective plurality of versions of the Internet web page, wherein a click through rate for the first content object is determined for each of the plurality of positions, and wherein the estimated click through rate for the first content object is based on the click through rates for the first content object at each of the plurality of positions.

6. The system of claim 1, wherein the estimated click through rate for the first content object is based on a linear model using the determined click through rate for the first content object.

7. The system of claim 6, wherein estimating the click through rate for the first content object includes a logarithmic transformation to the linear model to create a logarithmic curve.

8. A method comprising:
displaying, by a computer system, content in a web page to a plurality of users over the Internet;
receiving, by the computer system over the Internet, a selection of the content in the Internet web page from the plurality of users, wherein the content comprises a first content object and a second content object, the first content object having a first page position on the Internet web page and the second content object having a second page position on the Internet web page;
determining, by the computer system based on the selection of content by the plurality of users, a click through rate for the first content object in the first page position and a click through rate for the second content object in the second page position;
estimating, by the computer system based on the determined click through rate for the first content object, a click through rate for the first content object at a third page position on the Internet web page;
estimating, by the computer system based on the determined click through rate for the second content object, a click through rate for the second content object at the third page position on the Internet web page;
ranking, by the computer system, the first content object and the second content object based on the estimated click through rate for the first content object and the estimated click through rate for the second content object.

9. The method of claim 8, wherein the third page position is a highest ranked position on the Internet web page.

10. The method of claim 8, further comprising repositioning one or more of the first content object and the second content object on the Internet web page in response to the ranking of the first content object and the second content object.

11. The method of claim 8, wherein receiving the selection of the content in the Internet web page includes receiving selections of a plurality of content objects in a respective plurality of positions on the Internet web page from the plurality of users.

12. The method of claim 8, wherein receiving the selection of the content in the Internet web page includes receiving selections for the first content object displayed to the plurality of users in a plurality of positions on a respective plurality of versions of the Internet web page, wherein a click through rate for the first content object is determined for each of the plurality of positions, and wherein the estimated click through rate for the first content object is based on the click through rates for the first content object at each of the plurality of positions.

13. The method of claim 8, wherein the estimated click through rate for the first content object is based on a linear model using the determined click through rate for the first content object.

14. The method of claim 13, wherein estimating the click through rate for the first content object includes a logarithmic transformation to the linear model to create a logarithmic curve.

15. A tangible, non-transitory computer-readable medium storing instructions that, when executed by a computer system, cause the computer system to perform operations comprising:
displaying content in a web page to a plurality of users over the Internet;
receiving, by the computer system over the Internet, selection of the content in the Internet web page from the plurality of users, wherein the content comprises a first content object and a second content object, the first content object having a first page position on the Internet web page and the second content object having a second page position on the Internet web page;
determining, based on the selection of content by the plurality of users, a click through rate for the first content object in the first page position and a click through rate for the second content object in the second page position;
estimating, based on the determined click through rate for the first content object, a click through rate for the first content object at a third page position on the Internet web page;
estimating, based on the determined click through rate for the second content object, a click through rate for the second content object at the third page position on the Internet web page;
ranking the first content object and the second content object based on the estimated click through rate for the first content object and the estimated click through rate for the second content object.

16. The computer-readable medium of claim 15, wherein the medium further stores instructions for repositioning one or more of the first content object and the second content object on the Internet web page in response to the ranking of the first content object and the second content object.

17. The computer-readable medium of claim 15, wherein receiving the selection of the content in the Internet web page includes receiving selections of a plurality of content objects in a respective plurality of positions on the Internet web page from the plurality of users.

18. The computer-readable medium of claim 15, wherein receiving the selection of the content in the Internet web page includes receiving selections for the first content object displayed to the plurality of users in a plurality of positions on a respective plurality of versions of the Internet web page, wherein a click through rate for the first content object is determined for each of the plurality of positions, and wherein the estimated click through rate for the first content object is based on the click through rates for the first content object at each of the plurality of positions.

19. The computer-readable medium of claim 15, wherein the estimated click through rate for the first content object is based on a linear model using the determined click through rate for the first content object.

20. The computer-readable medium of claim 19, wherein estimating the click through rate for the first content object includes a logarithmic transformation to the linear model to create a logarithmic curve.
